(19) United States
(12) Patent Application Publication
(10) Pub. No.: US 2004/0018949 A1
(43) Pub. Date: Jan. 29, 2004

(54) Semiconductor process residue removal composition and process

(75) Inventor: Wai Mun Lee, Fremont, CA (US)

Correspondence Address: Pennie & Edmonds, LLP, 3300 Hillview Avenue, Palo Alto, CA, 94304, US

(73) Assignee: Wai Mun Lee

(21) Appl. No.: 10/442,858

(22) Filed: May 20, 2003

Related U.S. Application Data
(63) Continuation-in-part of application No. 10/160,035, filed on Jun. 4, 2002, now Pat. No. 6,564,812.
Application No. 10/160,035 is a continuation of application No. 09/444,548, filed on Nov. 22, 1999, now Pat. No. 6,399,551.
Application No. 09/444,548 is a division of application No. 08/815,616, filed on Mar. 11, 1997, now Pat. No. 6,121,217.
Application No. 08/815,616 is a continuation-in-part of application No. 08/628,060, filed on Apr. 17, 1996, now Pat. No. 6,187,730.
Application No. 08/628,060 is a continuation-in-part of application No. 08/078,657, filed on Jun. 21, 1993, now abandoned.
Application No. 08/078,657 is a continuation-in-part of application No. 07/911,102, filed on Jul. 9, 1992, now Pat. No. 5,334,332.
Application No. 07/911,102 is a continuation-in-part of application No. 07/610,044, filed on Nov. 5, 1990, now Pat. No. 5,279,771.

(51) Int. Cl. C11D 1/00; B08B 3/14

(52) U.S. Cl. 510/175; 510/178; 134/42

(57) ABSTRACT

A two carbon atom linkage alkanolamine compound composition comprises the two carbon atom linkage alkanolamine compound, chelating agent, and optionally, an aqueous hydroxylamine solution. The balance of the composition is made up of water, preferably high purity deionized water, another suitable polar solvent, or a combination thereof. A process for removing photoresist or other residue from a substrate, such as an integrated circuit semiconductor wafer including titanium metallurgy, comprises contacting the substrate with the composition for a time and at a temperature sufficient to remove the photoresist or other residue from the substrate. Use of the two carbon atom linkage alkanolamine compound in the composition and process provides superior residue removal without attacking titanium or other metallurgy, oxide or nitride layers on the substrate.

CROSS REFERENCE TO RELATED APPLICATIONS

This application is a continuation-in-part of copending U.S. application Ser. No. 10/160,035, filed Jun. 4, 2002, which is a continuation of U.S. application Ser. No. 09/444,548, filed on Nov. 22, 1999, now U.S. Pat. No. 6,399,551, which is a divisional of U.S. application Ser. No. 08/815,616, filed on Mar. 11, 1997, now U.S. Pat. No. 6,121,217, which is a continuation-in-part of U.S. application Ser. No. 08/628,060, filed on Apr. 17, 1996, now U.S. Pat. No. 6,187,730, which is a continuation-in-part of U.S. application Ser. No. 08/078,657, filed on Jun. 21, 1993, now abandoned, which is a continuation-in-part of U.S. application Ser. No. 07/911,102, filed on Jul. 9, 1992, now U.S. Pat. No. 5,334,332, which is a continuation-in-part of U.S. application Ser. No. 07/610,044, filed on Nov. 5, 1990, now U.S. Pat. No. 5,279,771.

### FIELD OF THE INVENTION

The present invention relates generally to a cleaning composition and process for removal of organic, organometallic, and/or metal oxide residues from substrates. More particularly, it relates to such a composition and process for removing semiconductor device fabrication residues from semiconductor device substrates, such as etching residues after plasma etching processes in the fabrication of integrated circuits on silicon wafers and similar processes. Most especially, it relates to such a composition and process which is effective for the removal of these materials while avoiding substantial attack on metal or insulation layers employed in integrated circuits, including titanium layers.

### BACKGROUND OF THE INVENTION

As integrated circuit manufacturing has become more complex and the dimensions of circuit elements fabricated on silicon or other semiconductor wafers have become smaller, continued improvement in techniques used to remove residues formed from such materials has been required. Oxygen plasma oxidation is often used for removal of photoresist or other polymeric materials after their use during the fabrication process has been completed. Such high energy processes typically result in the formation of organometallic and other residues on sidewalls of the structures being formed in the fabrication process.

A variety of metal and other layers are commonly employed in integrated circuit fabrication, including aluminum, aluminum/silicon/copper, titanium, titanium nitride, titanium/tungsten, tungsten, silicon oxide, polysilicon crystal, and the like. The use of such different layers results in the formation of different organometallic residues in the high energy processes. In addition to being effective for removing such residues, stripping and cleaning compositions should also not attack the different metallurgies or insulation layers used in integrated circuit fabrication.

A variety of residue removal compositions and processes suitable for integrated circuit fabrication have been developed and marketed by EKC Technology, Inc., the assignee of the present application. Some of these compositions and processes are also useful for stripping photoresist, polyimide or other polymeric layers from substrates in integrated circuit fabrication, and EKC has also developed a variety of compositions and processes for stripping such polymeric layers from substrates in integrated circuit fabrication. Such compositions and processes are disclosed in the following commonly assigned issued patents: U.S. Pat. No. 5,482,566, issued Jan. 9, 1996 to Lee; U.S. Pat. No. 5,399,464, issued Mar. 21, 1995 to Lee; U.S. Pat. No. 5,381,807, issued Jan. 17, 1995 to Lee; U.S. Pat. No. 5,334,332, issued Aug. 2, 1994 to Lee; U.S. Pat. No. 5,279,771, issued Jan. 18, 1994 to Lee; U.S. Pat. No. 4,824,763, issued Apr. 25, 1989 to Lee and U.S. Pat. No. 4,395,348, issued Jul. 26, 1983 to Lee. These compositions have achieved substantial success in integrated circuit fabrication applications. However, further development of integrated circuits and their fabrication processes have created a need for improvement in residue removal compositions and processes.

As a result of a continuous effort to decrease critical dimension size in the integrated circuit industry, such as in the fabrication of sub-micron size devices, etching residue removal and substrate compatibility with chemicals employed in wet processing is becoming more and more critical for obtaining acceptable yield in very large scale integration (VLSI) and ultra large scale integration (ULSI) processes. The composition of such etching residue is generally made up of the etched substrates, underlying substrate, photoresist and etching gases. The substrate compatibility of the wafers with wet chemicals is highly dependent on the processing of the polysilicon, multilevel interconnection dielectric layers and metallization in thin film deposition, etching and post-etch treatment of the wafers, which are often quite different from one fabrication process to another. Some of the above compositions have produced corrosion on certain metal substrates, such as those including a titanium metal layer. Titanium has become more widely used in semiconductor manufacturing processes. It is employed both as a barrier layer to prevent electromigration of certain atoms and as an antireflector layer on top of other metals.

### SUMMARY OF THE INVENTION

Accordingly, it is an object of this invention to provide an improved composition for residue removal and process using such a composition suitable for meeting current semiconductor fabrication requirements.

It is another object of the invention to provide such a composition and process which is suitable for removing residues from wafers and other substrates including one or more metal or metal alloy layers without substantial attack on such layers.

The attainment of these and related objects may be achieved through use of the residue removal composition and process herein disclosed. A residue removal composition in accordance with this invention comprises a two carbon atom linkage alkanolarnine compound, a chelating agent or corrosion inhibitor, optionally, an aqueous hydroxylamine solution and desirably a balance of water, another suitable polar solvent or a combination thereof. A process for removing a residue from a substrate in accordance with this invention comprises contacting the substrate with a composition that contains a two carbon atom linkage alkanolamine compound for a time and at a temperature sufficient to remove the residue from the substrate.

In practice, it has been found that use of a two carbon atom linkage alkanolamine compound gives a residue removing composition that can attack, e.g., titanium, substantially less than prior cleaning compositions. At the same time, the two carbon atom linkage alkanolamine compound containing composition gives equivalent performance as a residue removing composition.

The attainment of the foregoing and related objects, advantages and features of the invention should be more readily apparent to those skilled in the art, after review of the following more detailed description of the invention, taken together with the drawings, as described herein.

### BRIEF DESCRIPTION OF THE DRAWING

FIGS. 1-8 are scanning electron microscope (SEM) photographs showing comparative results achieved using the compositions and processes of the present invention.

### DEFINITIONS

Unless otherwise specified, all percentages expressed herein should be understood to refer to percentages by weight. Also, the term “about,” when used in reference to a range of values, should be understood to refer to either value in the range, or to both values in the range.

As used herein, the phrases “contains substantially no” and “is substantially free from,” in reference to a composition or to a specific element of a composition, should be understood to mean that the composition contains less than about 2%, preferably less than about 1%, more preferably less than about 0.1%, most preferably less than about 0.01%, of the specific element mention thereafter. Preferably, when one of the aforementioned phrases is used, the composition is completely free of any added element specifically mentioned thereafter.

Unless otherwise specified, and wherever possible, a compound should generally not be characterized under more than one enumerated element of the composition according to the invention. If a compound is capable of being characterized under, for example, two enumerated elements of the composition, such a compound may be characterized herein only under either one of the two enumerated elements, but not under both. At times, the distinction may be made based on the content of the compound in the composition. For instance, catechol or gallic acid can act primarily as a corrosion inhibitor at “high” concentrations, ie. about 0.5% to 20%, or primarily as a metal chelator at “low” concentrations, i.e., in the ppm to 0.5 wt % range. As one of skill in the art would understand, the chelating agent may have a corrosion inhibiting effect as well.

### DETAILED DESCRIPTION OF THE PREFERRED EMBODIMENTS

The two carbon atom linkage alkanolamine compounds suitable for use in the invention have the structural formula,

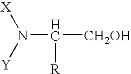

wherein X and Y are, independently in each case, hydrogen, methyl or ethyl, and R is hydrogen or an alkyl group containing from 1 to 4 carbon atoms. The two carbon atom linkage alkanolamine compounds useful in the present invention preferably have relatively high boiling points, e.g., such as 75° C. or above. Preferred specific examples of such two carbon atom linkage alkanolamine compounds include monoethanolamine (“MEA”), 2-amino-1-propanol (“monoisopropanolamine” or “MIPA”), and 2-(2-aminoethoxy) ethanol (“DGA”).

Examples of other two carbon atom linkage alkanolamine compounds include, but are in no way limited to, 2-(N-methylamino) ethanol (“monomethyl ethanolamine” or “MMEA”), 2-[N,N-(2-aminoethyl)-amino]-ethanol (“diethanolamine” or “DEA”), 2-[(2-aminoethyl)-(2-hydroxyethyl)-amino]-ethanol (“N,N-bis-hydroxyethyl-ethylenediamine”), 2-[N,N-(2-hydroxyethyl)-amino]-ethanol (“triethanolamine” or “TEA”), N-aminoethyl-N′-hydroxyethyl-ethylenediamine, N,N′-dihydroxyethyl-ethylenediamine, 2-[2-(2-aminoethoxy)-ethylamino]-ethanol, 2-[2-(2-aminoethylamino)-ethoxy]-ethanol, 2-[2-(2-aminoethoxy)-ethoxy]-ethanol, tertiarybutyldiethanolamine, isopropanolamine, diisopropanolamine, 3-amino-1-propanol (“n-propanolamine” or “NPA”), isobutanolamine, 2-(2-aminoethoxy)-propanol; 1-hydroxy-2-aminobenzene; or the like, or any combination thereof.

The composition desireably contains at least about 10% by weight of at least one two carbon atom linkage alkanolamine compound, from about 5% to about 40% by weight of gallic acid, catechol, another chelating agent, or a mixture thereof, and optionally, up to about 50 percent by weight of a 50% by weight aqueous hydroxylarnine solution. The balance of the composition is desireably made up of water, preferably high purity deionized water, or other suitable polar solvent. The composition preferably includes from about 10% to about 80% by weight of at least one two carbon atom linkage alkanolamine compound, from about 5% to about 30% by weight of the gallic acid or catechol, from about 10% to about 30% of the hydroxylamine solution, with the remaining balance preferably being water or other suitable polar solvent.

In practice, it appears that the chelating agent enhances the ability of the two carbon atom linkage alkanolamine compound to remove the residue. At the same time, the presence of the chelating agent helps to prevent attack on the metallurgy. Examples of chelating agents include, but are in no way limited to, mono-, di-, or multi-hydroxybenzene-type compounds, e.g., such as catechol, butylated hydroxytoluene (“BHT”), and the like, or a combination thereof; carboxylic acid containing compounds, e.g., monocarboxylic acids such as formic acid, acetic acid, propionic acid, valeric acid, caproic acid, octanoic acid, acrylic acid, methacrylic acid, crotonic acid, benzoic acid, toluic acid, phenylacetic acid and the like; dicarboxylic acids such as oxalic acid, malonic acid, succinic acid, glutamic acid, adipic acid, maleic acid, fumaric acid, phthalic acid, isophthalic acid, terephthalic acid and the like; tricarboxylic acids such as citric acid, aconitic acid, trimellitic acid and the like; hydoxycarboxylic acids such as glycolic acid, lactic acid, 2-hydroxybuteric acid, tartaric acid, malic acid, salicylic acid, and the like; ketocarboxylic acids, such as acetoacetic acid, ketoglutaric acid and the like; aminocarboxylic acids such as aspartic acid, glutamic acid and the like; aminopolycarboxylic acids such as ethylenediamine tetraacetic acid (EDTA) and the like; compounds containing both hydroxyl and carboxylic acid moieties, e.g., such as gallic acid, and the like; aromatic compounds containing thiol groups, e.g., such as thiphenol; amino-carboxylic acids; diamines, e.g., such as ethylene diamine; polyalcohols; polyethylene oxide; polyamines; polyimines or the like; other organic acid chelating agents such as, pyruvic acid, phosphonic acid and the like; or a combination of any such chelating agents. Alternately or additionally, some chelating agents are described in commonly assigned U.S. Pat. No. 5,672,577, issued Sep. 30, 1997 to Lee, the disclosure of which is incorporated herein by reference.

In one embodiment, the composition according to the invention also contains a salt of hydrofluoric acid and a base that is substantially free from metal ions (hereinafter “HF-base salt,” without intent to limit). An example of such an HF-base salt includes, but is in no way limited to, ammonium fluoride. In an alternate embodiment, the composition according to the invention is substantially free from HF-base salts.

In one embodiment, the composition according to the invention also contains water. In an alternate embodiment, the composition according to the invention is substantially free from water.

In one embodiment, the composition according to the invention also contains a polar organic solvent. Suitable examples of polar organic solvents for the composition according to the invention include, but are in no way limited to, dimethyl sulfoxide, ethylene glycol, ethylene glycol alkyl ether, diethylene glycol alkyl ether, triethylene glycol alkyl ether, propylene glycol, propylene glycol alkyl ether, dimethyl sulfoxide, N-substituted pyrrolidone, and the like, or any combination thereof. According to the present invention, water is separate from, and is not classified as, a polar organic solvent herein. Also, other elements of the invention are not classified as a polar organic solvent according to the present invention, e.g., two carbon atom linkage alkanolamine compounds. Other additional polar organic solvents as known in the art can also be used in the composition of the present invention. In an alternate embodiment, the composition according to the invention is substantially free from polar organic solvents as defined herein.

The residue cleaning compositions of the present composition are effective in removing organometallic and metal oxide residue from a variety of integrated circuit wafer substrates, including metal and metal alloy layers, such as containing aluminum, titanium, copper, and/or tungsten; oxide layers, such as silicon oxides; nitride layers, such as silicon nitride; and the like; or any combination thereof. The cleaning compositions of the present invention are also effective in removing organometallic and metal oxide residue generated on the substrate of etching equipment utilized in the fabrication of integrated circuits. Examples of commercially available etching equipment include that available from Lam Research, Tegal, Electrotech, Applied Materials, Tokyo Electron, Hitachi and the like.

The method of cleaning a substrate using the cleaning compositions of the present invention involves contacting a substrate having organometallic and metal oxide residue thereon with a cleaning composition of the present invention for a time and at a temperature sufficient to remove the residue. The substrate is generally immersed in the cleaning composition. The time and temperature are determined based on the particular material being removed from a substrate. Generally, the temperature is in the range of from about ambient or room temperature to about 120° C. and the contact time is typically from about 2 to 60 minutes.

The substrate may then be rinsed in a polar solvent, such as isopropyl alcohol, followed by a deionized water rinse. After being rinsed, the substrate can then be mechanically dried, such as with a spin drier, or nitrogen blow dried.

### EXAMPLES

Exemplary embodiments of the present invention will be illustrated by reference to the following examples, which are included to exemplify, but not to limit, the scope of the present invention.

### Examples 1-8

### Prior Art Compositions Containing 2-Carbon Alkanolamine Compounds

Table 1 below describes cleaning compositions A through H for Examples 1-8 to follow.

TABLE 1

| Clean- | | | | |
|---|---|---|---|---|
| ing | | Chelating | Hydroxy- | |
| compo- | Alkanolamine | Agent | lamine | Additional |
| sition | wt % | wt % | wt %* | Solvent wt % |
| A | DGA (60%) | 5% catechol | 30% | |
| B | MIPA (55%) | 10% gallic acid | 30% | 5% water |
| C | MEA (60%) | | 35% | 5% water |
| D | MEA (60%) | 5% gallic acid | 35% | |
| E | MIPA (60%) | 5% catechol | 35% | |
| F | MEA (30%) + | 10% catechol | 30% | 5% water |
| | MIPA (25%) | | | |
| G | MEA (30%) + | 10% gallic acid | 30% | 5% water |
| | MIPA (25%) | | | |
| H | DGA (55%) | 10% gallic acid | 30% | 5% water |

*Hydroxylamine added as a 50 wt % solution in water

### Example 1

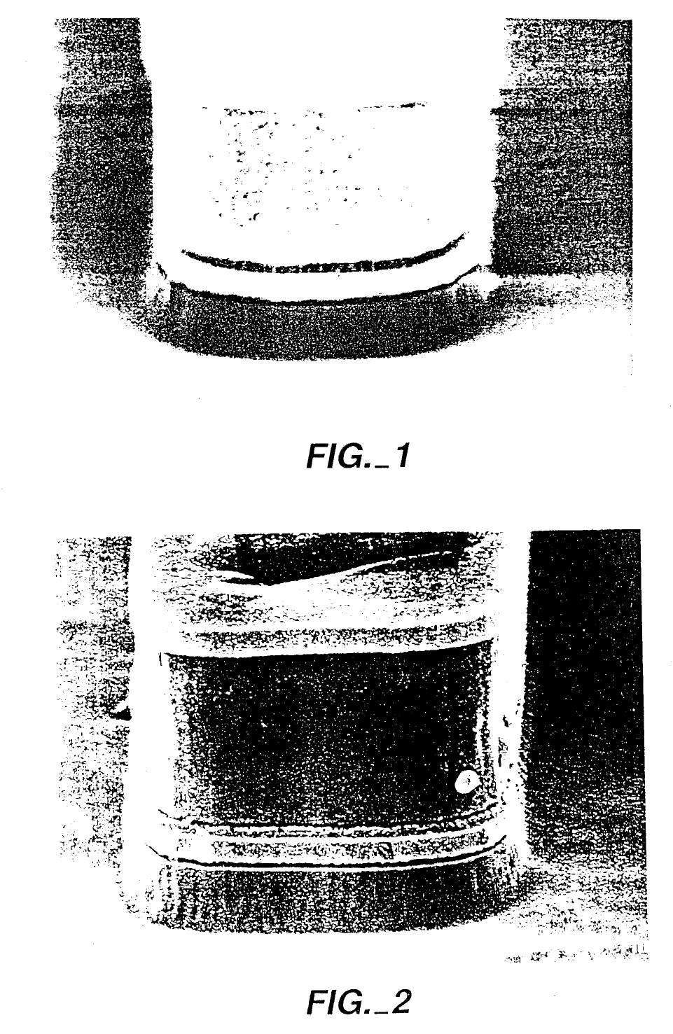

A semiconductor wafer having a patterned metal stack consisting of TiN/Al/Ti/TiN/Ti/SiO₂ was treated with composition A at 75° C. for 30 minutes to remove process residue from the wafer, for comparative purposes. FIG. 1 is a scanning electron microscope (SEM) photograph of the wafer after this treatment. Substantial undercutting of both Ti layers are visible in this photograph.

### Example 2

A semiconductor wafer having a patterned metal stack consisting of TiN/Al/Ti/TiN/Ti/SiO₂ was treated with compositions at 75° C. for 30 minutes to remove process residue from the wafer. FIG. 2 is a SEM photograph of the wafer after this treatment. No undercutting of the lower Ti layer is visible, and a slight undercutting of the upper Ti layer is visible.

### Example 3

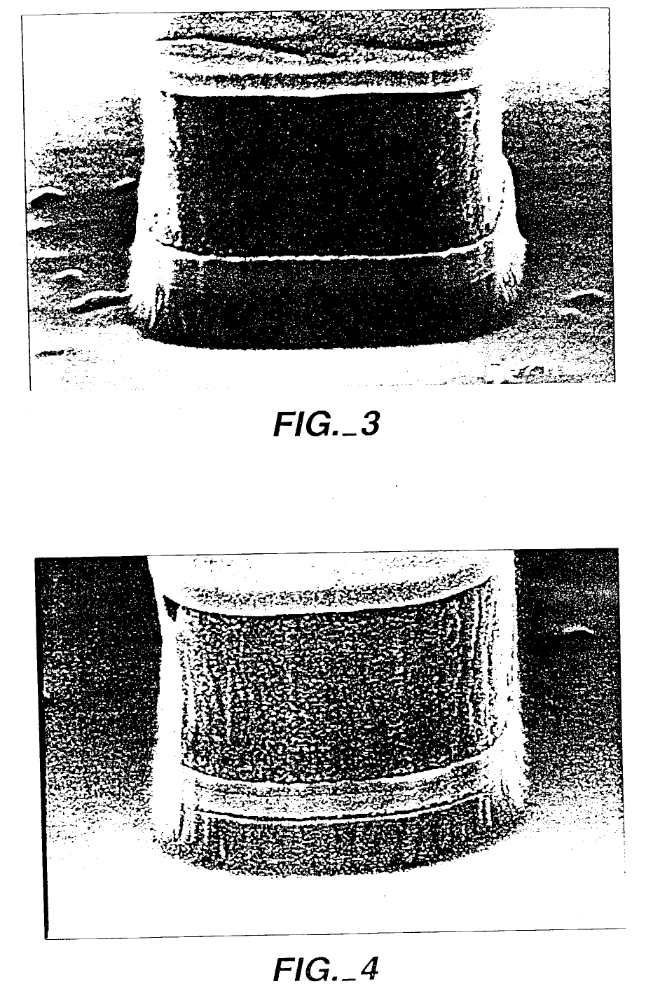

A semiconductor wafer having a patterned metal stack consisting of TiN/Al/Ti/TiN/Ti/SiO₂ was treated with composition C at 75° C. for 30 minutes to remove process residue from the wafer, as a control. FIG. 3 is a SEM photograph of the wafer after this treatment. Undercutting of both Ti layers is visible.

### Example 4

A semiconductor wafer having a patterned metal stack consisting of TiN/Al/Ti/TiN/Ti/SiO₂ was treated with composition D at 75° C. for 30 minutes to remove process residue from the wafer. FIG. 4 is a SEM photograph of the wafer after this treatment. A slight undercutting of the lower Ti layer is visible, and no undercutting of the upper Ti layer is visible.

### Example 5

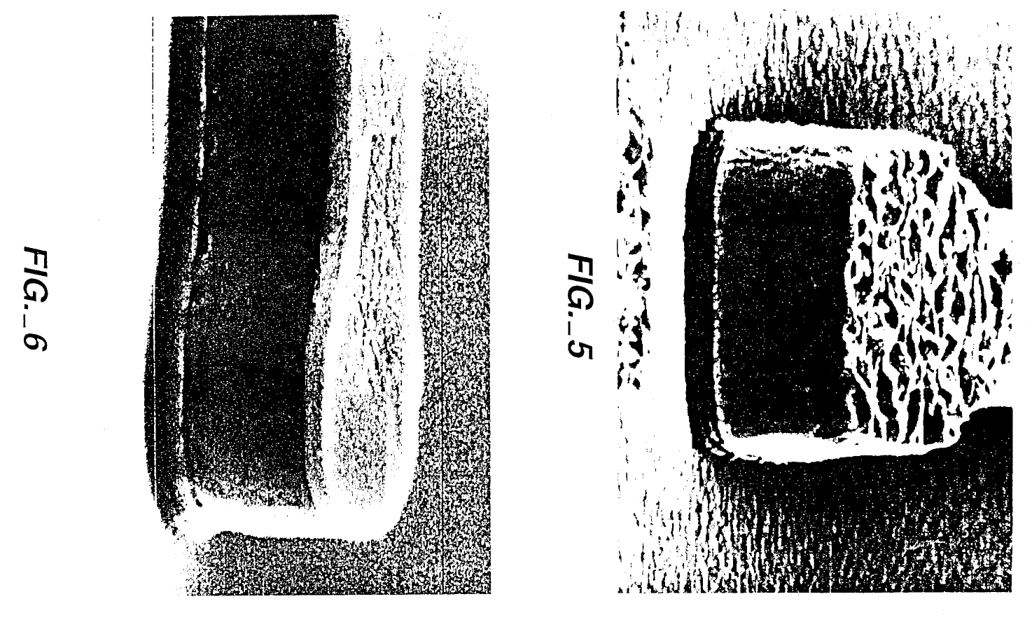

A semiconductor wafer having a patterned metal stack consisting of W/Ti/SiO₂ was treated with composition E at 75° C. for 30 minutes to remove process residue from the wafer. FIG. 5 is a SEM photograph of the wafer after this treatment. No undercutting of the Ti layer is visible.

### Example 6

A semiconductor wafer having a patterned metal stack consisting of TiN/Ti/Al/Ti/TiN/BPSG (boron phosphosilicate glass) was treated with composition F at 75° C. for 30 minutes to remove process residue from the wafer. FIG. 6 is a SEM photograph of the wafer after this treatment. No undercutting of the Ti layers is visible.

### Example 7

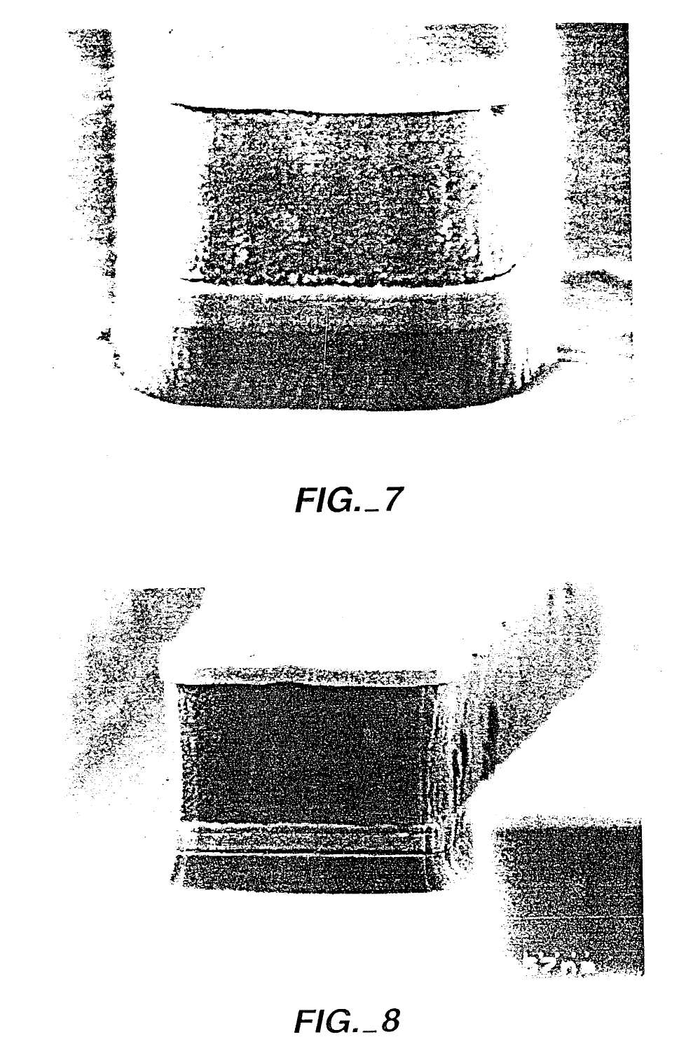

A semiconductor wafer having a patterned metal stack consisting of TiN/Al/Ti/TiN/Ti/SiO₂ was treated with composition G at 75° C. for 30 minutes to remove process residue from the wafer. FIG. 7 is a SEM photograph of the wafer after this treatment. No undercutting of the Ti layers is visible.

### Example 8

A semiconductor wafer having a patterned metal stack consisting of TiN/Al/Ti/TiN/Ti/SiO₂ was treated with composition H at 75° C. for 30 minutes to remove process residue from the wafer, for comparative purposes. FIG. 8 is SEM photograph of the wafer after this treatment. Undercutting of the Ti layers is visible.

The above examples show that compositions B, D, E, F and G successfully remove residues from substrates having a titanium metallurgy while reducing or eliminating attack on the titanium metallurgy. Increased amounts of the chelating agent produces an improved reduction of attack on the titanium metallurgy. The comparative compositions A, C and H all show substantial attack on the titanium metallurgy, even when a two carbon atom linkage alkanolamine compound is used in the absence of the chelating agent. When the chelating agent is used with an alkanolamine compound other than a two carbon atom linkage alkanolamine compound, the gallic acid or catechol does not show a similar reduction of attack of the composition on the titanium metallurgy.

It should now be readily apparent to those skilled in the art that a novel composition and process capable of achieving the stated objects of the invention has been provided. The improved two carbon atom linkage alkanolamine compound based composition and process using such a composition of this invention is suitable for meeting current semiconductor fabrication requirements. The composition and process is suitable for removing photoresist residues and other residues from wafers and other substrates including one or more metal layers, e.g., titanium, without substantial attack on such layers.

It should further be apparent to those skilled in the art that various changes in form and details of the invention as shown and described may be made. It is intended that such changes be included within the spirit and scope of the claims appended hereto.

What is claimed is:

1. A process for removal of residue from a semiconductor substrate, which comprises:
contacting the semiconductor substrate with an aqueous composition comprising:
a two carbon atom linkage alkanolamine compound of the following formula: 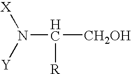
wherein X and Y are independently in each case, hydrogen, methyl or ethyl, and R is hydrogen or an alkyl group containing from 1 to 4 carbons;
a chelating agent; and
a polar organic solvent for a time and at a temperature sufficient to remove the residue from the substrate without damaging the substrate so that the semiconductor substrate can undergo continued fabrication of an integrated circuit, wherein the residue comprises residue from etching or plasma oxidation of the semiconductor substrate during fabrication of an integrated circuit.

2. The process of claim 1, further comprising hydroxylamine in an amount less than about 20% by weight.

3. The process of claim 1, wherein the polar organic solvent is selected from the group consisting of dimethyl sulfoxide, ethylene glycol, ethylene glycol alkyl ether, diethylene glycol alkyl ether, triethylene glycol alkyl ether, propylene glycol, propylene glycol alkyl ether, N-substituted pyrrolidone, ethylenediamine, and ethylenetriamine.

4. The process of claim 1, wherein the chelating agent is present in an amount of from about 5 percent to 30 percent by weight.

5. The process of claim 1 wherein the composition comprises a second two carbon atom linkage alkanolamine compound which is different than the first two carbon atom linkage alkanolamine, both said alkanolamine compounds are of the following formula: 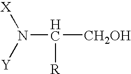
wherein X and Y are independently in each case, hydrogen, methyl or ethyl, and R is hydrogen or an alkyl group containing from 1 to 4 carbons.

6. The process of claim 2 wherein the composition comprises less than about 10% by weight hydroxylamine and less than about 10% of a chelating agent.

7. A process for removal of residue from a semiconductor substrate, which comprises:
contacting the semiconductor substrate with a composition consisting essentially of:
more than one two carbon atom linkage alkanolamine compound of the formula: 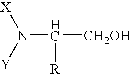
wherein X and Y are independently in each case, hydrogen, methyl or ethyl, and R is hydrogen or an alkyl group containing from 1 to 4 carbons;
at least one chelating agent;
an aqueous hydroxylamine solution; and
at least one polar organic solvent for a time and at a temperature sufficient to remove the residue from the substrate without damaging the substrate so that the semiconductor substrate can undergo continued fabrication of an integrated circuit, wherein the residue comprises residue from etching or plasma oxidation of the semiconductor substrate during fabrication of an integrated circuit.

8. The process of claim 1, wherein the semiconductor substrate comprises aluminum.

9. The process of claim 1, wherein the semiconductor substrate comprises titanium.

10. The process of claim 1, wherein the semiconductor substrate comprises copper.

11. The process of claim 7, wherein said composition comprises two different two carbon atom linkage alkanolamine compounds.

12. The process of claim 11, wherein said composition comprises two different chelating agents.

13. The process of claim 7, wherein said composition further comprises a salt of hydrofluoric acid and a base that is substantially free from metal ions.

14. The process of claim 13, wherein said salt is ammonium fluoride.

15. The process of claim 1, wherein the composition is free from water.

16. The process of claim 11, wherein at least one of said two carbon linkage alkanolamine compounds is selected from the group consisting of monoethanolamine, diethanolamine, and isopropanolamine.

17. The process of claim 16, wherein said two carbon atom linkage alkanolamine compounds are present in the amount of between about 10% to about 80%.

18. The process of claim 12, wherein at least one of said two carbon linkage alkanolamine compounds is selected from the group consisting of monoethanolamine, diethanolamine, and isopropanolamine.

19. The process of claim 1 8, wherein said two carbon atom linkage alkanolamine compounds are present in the amount of between about 10% to about 80%.

20. A process for removal of residue from a semiconductor substrate, which comprises;
contacting the semiconductor substrate with an aqueous composition comprising:
(a) about 10% to about 80% of a two carbon atom linkage alkanolamine compound of the following formula: 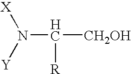
wherein X and Y are independently in each case, hydrogen, methyl or ethyl, and R is hydrogen or an alkyl group containing from 1 to 4 carbons;
(b) about 5% to about 40% of at least one chelating agent;
(c) less than about 30% of an aqueous hydroxylamine solution; and
(d) a polar organic solvent selected from the group consisting of dimethyl sulfoxide, ethylene glycol, ethylene glycol alkyl ether, diethylene glycol alkyl ether, triethylene glycol alkyl ether, propylene glycol, propylene glycol alkyl ether, N-substituted pyrrolidone, ethylenediamine, and ethylenetriamine;
for a time and at a temperature sufficient to remove the residue from the substrate without damaging the substrate so that the semiconductor substrate can undergo continued fabrication of an integrated circuit, wherein the residue comprises organometallic material; and
rinsing the composition from the semiconductor substrate.
